(19) United States
(12) Patent Application Publication
(10) Pub. No.: US 2008/0242583 A1
(43) Pub. Date: Oct. 2, 2008

(54) Composition and Method

(75) Inventors: Gay Joyce Cornelius, Cottingham (GB); Malcolm Tom Mckechnie, Hull (GB)

Correspondence Address: NORRIS, MCLAUGHLIN & MARCUS, 875 THIRD AVE, 18TH FLOOR, NEW YORK, NY, 10022, US

(73) Assignee: RECKITT BENCKISER (UK) LIMITED, Slough, Berkshire (GB)

(21) Appl. No.: 10/597,358

(22) PCT Filed: Feb. 9, 2005
(86) PCT No.: PCT/GB05/00449

§ 371 Date: Aug. 30, 2006

(30) Foreign Application Priority Data
Feb. 11, 2004 (GB) 0403008.6

(51) Int. Cl. C11D 1/72; C11D 3/00; C11D 1/66

(52) U.S. Cl. 510/470; 510/506; 510/504

(57) ABSTRACT

A cleaning composition comprising at least 80 percent by water at least 1 percent by weight of an amphiphile, and at least 0.005 percent by weight of hydrocarbon exhibits good cleaning performance and a visual indication of activity. The composition is on or adjacent to a phase boundary of its phase diagram and exhibits self-induced surface motility of the Marangoni type.

This invention relates to the field of cleaning. It relates in particular to a cleaning composition, and to a method of cleaning.

EP-A-330379 describes the use of cleaning compositions which contain at least one ether alcohol, water and a hydrocarbon in a single phase, respectively in the percent weight ratios 90-50:2-36:25-0.9. The composition is said to be suitable for removing oil adherent from surfaces e.g. rock cuttings produced during drilling operations for oil. The compositions are made by simply mixing the chemicals, hand shaking, and then allowing the mixture to separate into three phases. The middle phase was the cleaning composition, and was extracted and used for cleaning tests. This middle phase contained the ether alcohol in major proportion, and lesser amounts of water and hydrocarbon.

A disadvantage of this system is the large amount of alcohol ether present in the cleaning composition. The use of large amounts of many alcohol ethers is now restrained by legislation relating to VOCs (Volatile Organic Components).

There is a need for cleansing compositions with reduced levels of volatile compounds which clean surfaces, particularly hard surfaces, effectively. There is also a need for cleansing compositions which provide a visual cue to the user that they are working.

In accordance with a first aspect of the present invention there is provided a cleaning composition comprising at least 80 percent by weight water, at least 1 percent by weight of an amphiphile, and at least 0.005 percent by weight of a volatile hydrocarbon.

The composition may be in the form of a single phase or it may be present as two or three phases in mutual chemical equilibrium. Where the composition is a single phase, it has the advantage that it does not need to be mixed or shaken prior to use. Where the composition is in the form of 2 or 3 phases, the visual cleaning indication due to motility of the system is more visible. Preferably the composition is adjacent to a phase boundary on the three-component phase diagram for the composition. By this it is meant that a change in relative weight percentages of the three components of the composition caused by loss of only one component, whereby the weight percentage of that component is reduced by an absolute value of 1% or less, preferably 0.5% or less, more preferably 0.1% or less (expressed as percentage by weight of the total weight of the total composition), leads to a change in the number of phases present in the composition, for instance changing from a single phase to a 2 or 3 phase mixture.

In this specification when a percentage value is given for a component, it denotes the percentage by weight of that component, based on the total weight of the composition of which the component is part.

For the purpose of this specification an amphiphile is defined as a compound which possesses an affinity for an apolar compound and for a polar compound. Suitably it forms a loose association in a composition, coupling together other components of the composition, without forming a strongly micellar or lamellar structure, in the manner of a classical surfactant. Preferably it does not associate strongly with surfaces.

For some aspects, such as not needing to be shaken prior to use, the water the amphiphile and the hydrocarbon preferably co-exist without separating from each other, as layers. When the composition comprises 2 or more phases, it is preferably shaken prior to use.

Preferably, the composition has a water content of at least 90%, more preferably at least 94%, most preferably at least 96%, and especially at least 98%.

Preferably the aqueous composition contains at least 1.5% of an amphiphile, more preferably at least 2%, most preferably at least 2.5%. Mixtures of amphiphiles may be used.

Preferably the aqueous composition (as a single phase or as the aqueous layer, when there is separation of layers) contains up to 20% of an amphiphile, more preferably up to 8%, most preferably up to 4%.

Suitable amphiphiles include substituted pyrrolidones, especially 1-alkyl-2-pyrrolidones. Preferably the alkyl group has, on average, 4 to 16 carbon atoms, more preferably 6 to 14 carbon atoms, and most preferably 8 to 12 carbon atoms. Preferably the alkyl group is linear. 1-octyl 2-pyrollidone is particularly suitable.

Quaternary N-alkylaldonamides may also be used as the amphiphile, for instance N-decylisosaccharinamide or N-octylribonamide and mixtures thereof.

Short alkyl chain alkyl glucosides, preferably with an alkyl chain length of C₁₀ or less, more preferably C₈ or less are also suitable. Mono-, di-, tri, or tetra-glucosides or mixtures thereof are preferred.

Suitable amphiphiles include glycol ethers and these are particularly preferred.

Preferred glycol ethers are compounds of the formula R¹O(RO)ₙH (I) in which R is a C₁-C₈ alkylene group (preferably C₁-C₄), n is at least 1 (preferably 2-4) and R¹ is a C₁-C₈ alkyl group (preferably C₁-C₄) or, especially, an optionally substituted aryl group). A preferred optionally substituted aryl group is an optionally substituted phenyl group. Substituents of a aryl or phenyl group include C₁-C₄ alkyl groups, C₁-C₄ alkoxy groups, C₁-C₄ haloalkyl groups, cyano groups, amido groups, amine groups, and halogen atoms. Preferred halogen atoms, including comprised within haloalkyl groups, include fluorine, chlorine and bromine atoms. There may suitably be 1-3 substituents. Preferably, however, an aryl or phenyl group is unsubstituted.

Specific examples of suitable glycol ethers not having an aromatic group include:

ethoxypropoxypropanol (EDP)

ethoxyethoxypropanol

propoxyethoxypropanol

propoxypropoxypropanol

butoxypropoxyethanol

butoxybutoxyethanol

butoxyethoxyethanol (BDGE)

ethoxypropanol (EP)

butoxyethanol (BE)

butyldiglycolether.

Specific examples of suitable, and preferred, glycol ethers having an aromatic group include:

ethylene glycol phenyl ether (EPh)

phenoxypropanol (PhP)

phenoxypropoxypropanol (PhDP).

Particularly preferred are 2-butoxyethanol, diethylene glycol monohexyl ether or phenoxyethanol, and mixtures thereof.

Short chain alcohols are suitable amphiphiles for use in compositions of the invention, but are not preferred when used as the sole amphiphile present. Particularly suitable for use in combination with other amphiphiles as described above are ethanol, propanol, isopropanol, n-butanol and t-butanol. Mixtures of these alcohols with other amphiphiles may also be used in order to modify the phase boundaries relating to the compositions of the invention.

Especially preferred amphiphiles are compounds which at no concentration are classified as VOCs as set out in the regulations of the US Government Environmental Protection Agency (EPA) for the envisaged application (preferably as cleaners in a household environment) at the priority date of this patent application. Other preferred amphiphiles are compounds which are classified as VOCs by the EPA regulations but only at particular concentration levels; and which are present below such levels, in the composition of the invention.

If water and an amphiphile of use in the present invention are shaken together in a two-phase zone of the phase diagram, away from a phase boundary, two easily-visible phases will form. In some cases the water-rich phase will be below the amphiphile-rich phase (Amphiphiles A). In other cases the water-rich phase will be above the amphiphile-rich phase (amphiphiles B). Provided that the proportions can be adjusted so that the composition is in accordance with the first aspect, the use of all such amphiphiles A and B, of differing densities, is covered. Preferably, however, the amp hiphiles used in this invention are of the type B.

Especially preferred glycol ethers are compounds having a vapour pressure of less than 0.1 mmHg at 20° C.

The composition of the invention further contains a hydrocarbon. The hydrocarbon is preferably insoluble in water, by which it is meant that its solubility in distilled water at 25° C. is 0.001% by weight of solution or less. Preferably the composition contains at least 0.005% of a hydrocarbon, more preferably at least 0.01%, and even more preferably at least 0.05%. Higher levels are more effective such as 0.1% or more. Preferably the composition contains only up to 5% of a hydrocarbon, more preferably up to 2%, yet more preferably up to 0.8%, and most preferably up to 0.5% such that the level of volatile material released to the atmosphere during use of the composition is minimised. Mixtures of suitable hydrocarbons may be employed in the compositions of the invention.

The hydrocarbon is suitably a paraffinic, including isoparaffinic compounds. The hydrocarbon may suitably be a hydrocarbon fragrance. Preferably it is a liquid under ambient conditions. Preferably the hydrocarbon has 5 or more carbon atoms, more preferably 8 or more. Preferably the hydrocarbon has up to 15 carbon atoms, more preferably up to 12 carbon atoms. When the hydrocarbon is a mixture, as will often be the case, these definitions still apply, as mean values.

When a hydrocarbon is present it tends to be lighter than any other phase, and at certain hydrocarbon levels may separate out.

Preferably a hydrocarbon present is significantly more volatile than the water or the amphiphile. By volatile it is meant that a material has a vapour pressure of 0.2 mmHg or more at 20° C.

In this specification when we mention an amphiphile or a hydrocarbon it is to be understood that there may be more than one of a said amphiphile or a hydrocarbon present. The weight percentage definitions denote the total complement of amphiphile or hydrocarbon compounds present.

Suitably the composition may contain an electrolyte, preferably an ionic salt. Suitable examples include alkali. metal salts, especially halides. Most preferred, for reasons which include cost and safety, is sodium chloride.

An electrolyte may be used to alter the phase diagram, shifting phrase boundaries so that the composition is on or adjacent to a phase boundary, as preferred by the first aspect of the present invention. When electrolyte is present, it is included with the water, treating water and electrolyte as a single component for the purpose of drawing up a three component phase diagram.

It is highly preferred for the compositions of the invention to include a fragrance in order to make more acceptable the odour of the compositions in a household cleansing composition. Preferably at least 0.1% by weight of fragrance is present, more preferably 0.4% or more, but preferably 1% or less, more preferably 0.8% or less. The fragrance is included with the hydrocarbon for the purpose of drawing up the three-component phase diagram of the composition. By fragrance is meant perfumer's oil without any base or extender included.

Compositions of the present invention may include low levels, preferably less than 1% by weight of the composition, of conventional adjuncts used in household cleaning products, provided that these do not have a substantial effect on the phase behaviour of the composition. In terms of drawing up a three-component phase diagram for the system, the skilled person would assign such components to be included with the water, amphiphile or hydrocarbon corner of the phase diagram based upon the Hansen solubility parameter for the component. Surfactant, which is a preferred ingredient, at a weight percentage of the composition from 0.01 to 0.1%, more preferably 0.03 to 0.05%, is included with the amphiphile on the phase diagram. Nonionic surfactant, such as alcohol ethoxylate, is particularly preferred when surfactant is present. Biostatic agents such as cationic biostats or suitably PCMX (parachlorometaxylenol) may also be incorporated in compositions of the invention. Bleach systems such as or peroxide-based bleaches may also be used in compositions of the invention.

Remarkably, we have found that compositions of the invention may apparently exhibit behaviour of the Marangoni type. When a jar of a preferred composition of the invention is opened and exposed to the environment the surface may be seen to “twitch”. This effect is believed to be due to surface tension gradients, perhaps allied to crossing of phase boundaries, when volatile compounds evaporate. We have observed such compositions in which, when the lid is replaced on the jar, the “twitching” stops. The “twitching” may be if the composition is pipetted onto a surface.

By “twitching” we mean that the surface of the composition exhibited motility not induced by an external agent, such as an object applied to it; in other words a self-induced motility.

In accordance with a second aspect of the present invention there is provided a cleaning composition comprising water, a hydrocarbon and an amphiphile as detailed hereinbefore, which composition exhibits Marangoni behaviour when exposed to air. Preferably the composition exhibits-Marangoni behaviour only when exposed to air. Preferably the composition is in the form of 2 or 3 phases in mutual equilibrium prior to exposure to the air.

For the purpose of this specification the Marangoni effect may be defined as the effect in a liquid when surface tension gradients cause movement of the liquid. The surface tension gradients may result from concentration changes (Gibbs effect), which may themselves arise from evaporation, or from inadequate mixing, following separation or segregation in a container, or by the application of a stress, for example a shear force (as by a wiping action).

Without wishing to be bound by theory, it is thought that the Marangoni effect may give rise to cleaning benefits exhibited by compositions of the invention. Compositions exhibiting the Marangoni effect may exhibit a tendency to “creep” into small spaces. Evaporation of a compound may lead to changes in surface tension and to surface motility, causing the composition to move, for example into and then out of a crack, drawing soils with it. The use of amphiphiles may assist separation of dirt from a substrate. Amphiphiles generally do not promote adhesion with a surface but they may wet well. Thus amphiphile-containing compositions which exhibit the Marangoni effect may move into small interstices or may move between a surface and a soil deposit, “lifting” the latter.

In accordance with a third aspect of the present invention there is provided a method of cleaning a soiled substrate, comprising the application to the soiled substrate of a composition of the first and/or second aspect of the present invention, as defined above.

Another aspect of the invention is the use of compositions as described above for household substrate cleaning.

Another aspect of the invention provides a packaged household cleansing composition, wherein the cleansing composition is a composition as described above for the other aspects of the invention.

The substrate may be, for example, a hard surface, for example, a surface in the kitchen or bathroom, including a work surface, floor, tile, glass, sanitaryware item, window, crockery item or a domestic appliance; or a fabric surface, for example a clothing or upholstery item.

The soiling on the substrate may, for example, be grease, a protein stain, wine, fruit juice or make-up.

Preferred compositions of the present invention are provided in containers which have a manually operable pump such as a “trigger spray”, or in containers from which the contents are poured, or expressed by squeezing the container, or in aerosol dispensers. In aerosol dispensers the hydrocarbon of the composition may be the same as the propellant, and evaporation of propellant could itself induce a Marangoni effect.

Containers containing ready-to-use compositions of the invention constitute a further aspect of the present invention, notably containers adapted to deliver such compositions directly to hard surfaces (for example aerosols and “trigger sprays”). Containers containing aqueous dilutable compositions (i.e. comprising the components of the composition without water, the water being added by the user of the product prior to use) constitute a still further aspect. This gives the advantage of reduced packaging and transport costs.

The invention will now be further described, by way of example, with reference to the following example.

In these examples the three materials studied were deionised water, isoparaffinic solvent ISOPAR E and, as glycol ether, DOWANOL EPh (ethylene glycol phenyl ether). ISOPAR E and DOWANOL EPh are Trade Marks.

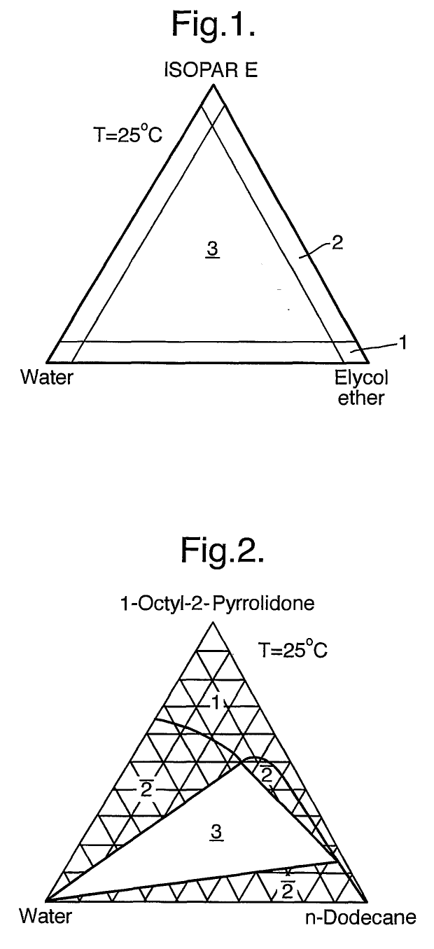

First, to “scope” the work the three materials were mixed together in different proportions and allowed to separate. As a result the phase diagram shown in FIG. 1 was plotted. To our surprise, in the large, triangular central region of the ternary phase diagram, denoting the presence of three distinct phases, it was the lower phase which was the glycol ether-rich phase, and the middle phase which was the water-rich phase. This was different to the finding presented in EP 330379A.

It will be seen that the phase diagram shows phase changes at each corner, the water-rich corner being the region of greatest interest to us. Small changes in the composition, for example induced by preferential evaporation of one component, are likely to cause the composition to cross one or more phase boundaries. This is believed to be of significance in the findings that we report below.

A representative material having three distinct layers region was analysed as follows, for the content of each layer. The total of each layer does not come to exactly 100%, due to experimental tolerance. However there were no further materials present.

Top Layer—ISOPAR E-Rich layer
Water level=less than 0.1% (average of 3 readings)
ISOPAR E level=99.8% (average of 3 readings)
DOWANOL EPh level=1.2% (average of 3 readings)

### Middle Layer—Water-Rich Layer

Water level=96.2% (average of 6 readings)
ISOPAR E level=less than 0.1% (average of 3 readings)
DOWANOL EPh level=2.6% (average of 3 readings)

### Bottom Layer—EPh-Rich Layer

Water level=9.4% (average of 3 readings)
ISOPAR E level=4.3% (average of 3 readings)
DOWANOL EPh level=85.3% (average of 3 readings)

Based on this analysis and our desire to aim for an aqueous cleaning composition, a series of test compositions were formulated based on the aqueous composition, corresponding to the middle layer, as set out in the table below:

| | CONCENTRATION OF | | | |
|---|---|---|---|---|
| COMPO- | INGREDIENTS | | | |
| SITION | WATER | ISOPAR E | DOWANOL | |
| NO. | (g) | (g) | EPh (g) | OBSERVATIONS |
| 1 | 96.2 | 0.11 | 2.6 | 2 phases. |
| | | | | 2 mm |
| | | | | layer on top |
| | | | | of aqueous |
| | | | | layer |
| 2 | 9.625 | 0.015 | 0.261 | Clear, 1 |
| | | | | phase, with |
| | | | | oil drops on |
| | | | | top |
| 3 | 9.73 | 0.013 | 0.261 | Clear, 1 |
| | | | | phase |
| 4 | 9.72 | 0.029 | 0.27 | Clear, 1 |
| | | | | phase with |
| | | | | small drops |
| | | | | at bottom |

Any separated material on top of the aqueous composition is hydrocarbon-rich material, and that any composition separated at the bottom of the aqueous composition is glycol ether-rich material.

Each composition was then subjected to as assessment of its properties. A few drops of each composition was pipetted from the central region of a vial, without prior shaking, onto a clean laboratory bench top and observed for “twitching” behaviour. Subsequently, a few drops of each composition was applied to pencil marks on a horizontal enamel surface, and after a period removed by gentle wiping. The results were as follows:

| | |
|---|---|
| COMPOSITION | OBSERVATIONS |

| NO. | “TWITCHING” | CLEANING |
|---|---|---|
| 1 | Surface in vial | Cleaned pencil |
| | “twitched”. Stayed | marks |
| | still on bench | |
| 2 | Surface in vial | Cleaned pencil |
| | “twitched”. Stayed | marks |
| | still on bench | |
| 3 | Stayed still in | Cleaned pencil |
| | vial and on bench | marks |
| 4 | Surface in vial | Cleaned pencil |
| | “twitched”. Stayed | marks |
| | still on bench | |
| Deionised water | — | Did not clean |
| (comparison) | | pencil marks |

In a further test composition no. 1 was assessed more closely. It was observed that the thin top layer, having risen to cover the aqueous layer, “twitched” excessively in the vial, when open for 10 minutes. The “twitching” terminated when the vial was stoppered.

When composition no. 1 was pipetted onto the bench careful observation showed that a top film separated, and “twitched”. We believe that this Marangoni-type activity was associated with evaporation of the ISOPAR E.

In another test we also carefully pipetted an aliquot of the thin top layer of composition no. 1 and spread this on top of a clean laboratory worktop. This composition also twitched, and it was also observed that it spread out itself, by a “creeping” action.

In a further experiment ISOPAR E was dropped onto the deionised water in a beaker, stirred to mix, and allowed to separate as a surface layer. It was observed that the system did not twitch. We inferred (with caution, for this was only a preliminary test) that it might be necessary for the glycol ether to be present for the “twitching” phenomenon to occur, even though it is only present in small amounts in the aqueous phase and in the hydrocarbon-rich phase.

Further tests were carried out, to test the possible effectiveness of composition no. 1 against stains on fabrics. In these tests approximately 100 ml of composition number 1 was pipetted onto a cellulosic pad, and pressed against a proprietary bought-in stained substrate, with another cellulosic pad, dry, underneath the stained substrate (so that the two cellulosic pads formed a sandwich, about the stained substrate. A heated iron (hot plate temperature 167° C.) was applied to the moistened pad. In this manner composition no. 1 was found to be effective at removing red wine staining from cotton fabric, grass staining from cotton fabric, make-up staining from silk fabric, and red wine staining from silk fabric. The cleaning action was to “drive” the respective stain through to the dry pad underneath.

FIG. 2 shows the phase diagram for another system of interest in this invention, 1-(n-octyl)-2-pyrrolidone/n-dodecane/water. It will be seen that this phase diagram also shows phase changes at the water-rich corner, moving from two phases (1-(n-octyl)-2-pyrrolidone/water) to three phases, to two phases (n-dodecane/water). Small changes in the composition, for example induced by preferential evaporation of one component, are again likely to cause the composition to cross a phase boundary. We believe this is of significance in this system in obtaining a “twitching” effect.

1. A cleaning composition comprising at least 80 percent by weight water, at least 1 percent by weight of an amphiphile, and at least 0.005 percent by weight of hydrocarbon.

2. A cleaning composition according to claim 1, wherein the water the amphiphile and the hydrocarbon co-exist as a single phase without separating from each other as layers.

3. A cleaning composition according to claim 1, wherein the composition contains at least 96% w/w water.

4. A cleaning composition according to claim 1, wherein the composition contains 2 to 8% by weight of amphiphile.

5. A cleaning composition according to claim 1, wherein the amphiphile is a glycol ether.

6. A cleaning composition according to claim 5, wherein the glycol ether is a compound of the formula R¹O(RO)ₙH in which R is a C₁-C₈ alkylene group, n is at least 1 and R¹ is a C₁-C₈ alkyl group, or is an optionally substituted aryl group.

7. A cleaning composition according to claim 6, wherein R¹ is a phenyl group.

8. A cleaning composition according to claim 1, wherein the amphiphile is a 1-alkyl-2-pyrrolidone.

9. A cleaning composition according to claim 1 wherein the hydrocarbon is present in an amount 0.05 to 0.5 percent by weight of the composition.

10. A cleaning composition comprising water, a hydrocarbon and an amphiphile, which composition exhibits Marangoni behaviour when exposed to air.

11. A method of cleaning a soiled substrate, comprising the application to the soiled substrate of a composition according to claim 1.

12. The use of a composition according to claim 1 for the cleaning of household substrates.

13. A packaged household cleaning product comprising a composition according to claim 1.

14. A cleaning composition according to claim 1 wherein the composition is in the form of two or three phases in mutual chemical equilibrium.

15. A cleaning composition according to claim 1 wherein the amphiphile is a quaternary N-alkylaldonamide.

16. A cleaning composition according to claim 1 wherein the amphiphile is an alkyl glucoside with an alkyl chain length of C₁₀ or less.

17. A cleaning composition according to claim 1 wherein the amphiphile is a short chain alcohol.

18. A cleaning composition according to claim 1 wherein the hydrocarbon has 5 or more carbon atoms.

19. A cleaning composition according to claim 1 wherein the said composition contains one or more of: electrolyte, fragrance, surfactant.

20. A cleaning composition according to claim 1 wherein the composition exhibits a self-induced motility.
